(19) United States
(12) Patent Application Publication
(10) Pub. No.: US 2018/0301714 A1
(43) Pub. Date: Oct. 18, 2018

(54) BATTERY ELECTRODE MATERIAL OF IONISED SODIUM AND PREPARATION METHOD THEREOF

(71) Applicant: Graduate School at Shenzhen, Tsinghua University, Shenzhen (CN)

(72) Inventors: QUAN-HONG YANG, Shenzhen (CN); SI-WEI ZHANG, Shenzhen (CN); WEI LV, Shenzhen (CN); FEI-YU KANG, Shenzhen (CN); CONG-HUI YOU, Shenzhen (CN); BAO-HUA LI, Shenzhen (CN); YAN-BING HE, Shenzhen (CN)

(21) Appl. No.: 16/017,957

(22) Filed: Jun. 25, 2018

Related U.S. Application Data
(63) Continuation-in-part of application No. PCT/CN2016/108631, filed on Dec. 6, 2016.

(30) Foreign Application Priority Data
Dec. 25, 2015 (CN) 201510991631.9
Dec. 25, 2015 (CN) 201510999992.8

(51) Int. Cl. H01M 4/88; H01M 4/66

(52) U.S. Cl. CPC H01M 4/8842; H01M 4/663; H01M 2004/021; H01M 4/8828; H01M 4/666

(57) ABSTRACT

A sodium ion battery electrode material is disclosed, the electrode material including a conductive porous material or a conductive porous composite. A sodium accommodating pore is defined inside the electrode material, effective pore diameter size for sodium ion storage in the sodium accommodating pore is in a range of 0.2-50 nm. A method for preparing the conductive porous composite and a sodium ion battery electrode are also provided.

### FIELD

The invention relates to battery electrode materials and preparing methods thereof.

### BACKGROUND

Limited lithium resources and costs limit its application to large scale energy storage systems such as smart grids and renewable energy.

Sodium ion is similar to lithium ion in battery systems. Sodium is more abundant, with low cost and good performance. The sodium ion battery has similar working principles with lithium ion battery, but the large radius of sodium ions makes it difficult for the selection of electrode materials. It is problematic to find sodium storage materials with stability and commercially availability. For example, graphite has excellent lithium storage performance, but due to mismatch of the larger sodium ions and graphite layer space, sodium ions cannot be reversely extraction and insertion between the graphite layers, resulting in low sodium storage capacity about 30 mAh/g. Silicon based material is not suitable for sodium storage because it cannot react with sodium ions. Therefore, more suitable and commercially available sodium storage materials are urgently needed.

### BRIEF DESCRIPTION OF THE DRAWING

Many aspects of the present disclosure can be better understood with reference to the following drawings. The components in the drawings are not necessarily to scale, the emphasis instead being placed upon clearly illustrating the principles of the present exemplary embodiment.

FIG. 1 is a flowchart illustrating a method for preparing of a conductive porous composite in an exemplary embodiment.

FIG. 2 is a flowchart illustrating a method for preparing creating sodium ion battery electrode in an exemplary embodiment.

### DETAILED DESCRIPTION

The one or more exemplary embodiments described are only part of the implementation of present disclosure, rather than the full embodiment. All other embodiments obtained by technicians in this field under the precondition of not doing creative work are covered by the protection of present disclosure.

Unless otherwise defined, all the technical and scientific terms used in this article are the same as those commonly understood. The terminology used in this specification is intended only to describe the purpose of the specific embodiment and is not intended to limit the present disclosure. The term “and/or” used in this article includes any and all combinations of one or more related items listed.

The following exemplary embodiment and the characteristics of the exemplary embodiment may be grouped together.

A sodium ion battery electrode made of materials that include a conductive porous material or a conductive porous composite is disclosed. There are pores which can store sodium ions in the electrode material, and the effective diameter of above pores is 0.2-50 nm.

The sodium accommodating pore is the pore capable of accommodating the free extraction and insertion of the sodium ions. The effective pore size refers to the pore diameter.

The effective pore diameter of the sodium accommodating pore in the electrode material is about 0.2-50 nm, which can allow the desolvent sodium ions, and also prevent the solvent groups from moving into the pore, which effectively inhibits the formation of solid electrolyte interface (SEI) membrane, so that the electrode material may have good electrochemical performance while improving the reversibility of sodium ion battery.

According to an exemplary embodiment, the conductive porous composite includes a carbon molecular membrane and a conductive porous material.

The conductive porous material includes one or more of the carbon porous material and the non-carbon porous material.

The carbon porous material includes, but is not limited to, one or more of glass carbon, template carbon, graphene, carbon molecular sieve, carbon nanotubes, graphite oxide, carbon nanoparticles, carbon quantum dots, activated carbon, and lignin.

The carbon porous material has good sodium ion transfer channel, and the solvated sodium ions formed by sodium ions and the solvent group cannot move into the pore, thus, effectively inhibiting the formation of SEI membrane. As such, the electrode material has good electrochemical performance, and carbon porous material has good conductivity and chemical stability while it is non-toxic, simple to process, and low cost.

The carbon porous material is a carbon molecular sieve. Preferably, the carbon molecular sieve includes but is not limited to one or more of several 3KT-172 type carbon molecular sieves, 1.5GN—H type molecular sieve, rock valley carbon molecular sieve, carbon molecular sieves CMS-180, CMS-200, CMS-220, CMS-230, CMS-240, and CMS-260.

Commercially available carbon molecular sieve pore diameter size is suitable, and the pore diameter distribution is narrow, which is suitable for the extraction and insertion of sodium ions. Storage capacity of sodium is high while initial Coulombic efficiency can reach more than 80%. The specific surface area value measured by the nitrogen temperature adsorption is less than 40 m²/g, the electrolyte solution cannot enter the sodium accommodating pore, and non-reversibility caused by the formation of SEI membrane is low. Compared with other materials, the production and preparation process of carbon molecular sieve is at a mature state and relatively inexpensive.

The non-carbon porous material includes, but is not limited to, one or more of porous polymers, porous metals, porous metal oxides, porous metal sulphides, porous silicide, porous nitride, and porous alloy materials.

The non-carbon porous material includes, but is not limited to, one or more of zeolite molecular sieve and modified zeolite molecular sieve.

The modified zeolite molecular sieve includes, but is not limited to, cation exchange modification, aluminum removal modification, molecular sieve skeleton of the impurity atom, and crystal substitution.

The modified zeolite molecular sieve includes, but is not limited to, one or more of TS-1 type molecular sieves, L-molecular sieves, ZSM-5 type molecular sieves, eight-surface zeolite molecular sieves, and mercerizing zeolite molecular sieves.

The carbon molecular membrane is made by carbonization of the precursor of carbon, and the precursor of the carbon includes, but is not limited to, one or more of a carbon-containing organic matter, a carbon-containing polymer material, and biomass.

The carbon precursor is cracked to form alkyl, benzene, and hydroxyl groups, and then a large quantity of amorphous carbon is formed, so that the mass fraction of the amorphous carbon molecule in the conductive porous material increases. The carbonized residual carbon can be introduced in the pore by one-dimensional direct growth, and cannot be cross-linked to form a three-dimensional network structure. A regular linear structure can be formed to increase the conductivity of the material.

The precursor of carbon enters into the pore of the conductive porous material through carbonization, and the formation of carbon molecular membrane is coated on the conductive porous materials, which reduces the pore diameter of conductive porous materials, so that the effective pore diameter reduces in size, by about 25-90%. The skeleton structure is unchanged and the material controllability is good.

Currently, the non-carbon molecular sieve is sold with large pore diameter, but the pore diameter distribution is narrow. The present disclosure describes a conductive porous composite being prepared by combining a carbon precursor with a non-carbon porous material, to reduce a pore diameter size of the non-carbon porous material effectively. The pore diameter size is reduced to provide suitable channels for the insertion of sodium ions, while obstructing the entry of sodium ions and solvent groups. The contact area between active substance and electrolyte is reduced effectively, the reaction of SEI film is reduced, and the reversibility capacity increases. Experimental results show that this type of material has sodium ions with high reversibility, good cyclic performance, and high commercial value.

The conductivity of the conductive porous composite is about 1-10³ S/cm.

Compared to a single conductive porous material, the conductivity of the conductive porous composite of present disclosure is determined by 4.1×10⁻⁵ S/CM increased to 860 S/cm, with conductivity increased 10²-10⁹ times.

A specific surface area of the sodium accommodating pore is about 0.5-2500 m²/g, and a volume of the sodium accommodating pore is about 0.0102-1.8 cm³/g.

It is understood that, the same conductive porous materials are used in different media to test the specific surface area, and the results are often different. The specific surface area in the present disclosure means N₂ adsorption test results.

An effective pore diameter of the sodium accommodating pores is about 0.3-20 nm, a specific surface area of the sodium accommodating pores is about 1-1000 m²/g, and a volume of the sodium accommodating pores is about 0.0136-1.5 cm³/g.

The effective pore diameter of the sodium accommodating pore is about 0.35-2 nm, the specific surface area of the sodium accommodating pore is about 2-300 m²/g, and the volume of the sodium accommodating pore is about 0.0136-0.17 cm³/g.

The effective pore diameter of the sodium accommodating pore is about 0.35-0.6 nm, the specific surface area of the sodium accommodating pore is about 5-78 m²/g, and the volume of the sodium accommodating pore is about 0.013-0.15 cm³/g.

Each of the sodium accommodating pores is about 0.2-5 nm in depth, preferably, the pore is about 0.6-3 nm in depth.

The sodium accommodating pores of the electrode material occupies 50-60% of the total quantity of pores in the material.

The present invention has found through multiple experiments that when the sodium accommodating pores of the electrode material occupy more than 50-60% of the total pores in the material, the sodium storage capacity of an exemplary sodium ion battery electrode prepared can reach the standard capacity of the sodium ion battery. The higher the percentage of the total pores in the material, the greater it is the capacity of sodium-ion battery electrode.

It is understood that the conductive porous material in the present disclosure can be obtained by means of purchase and preparation.

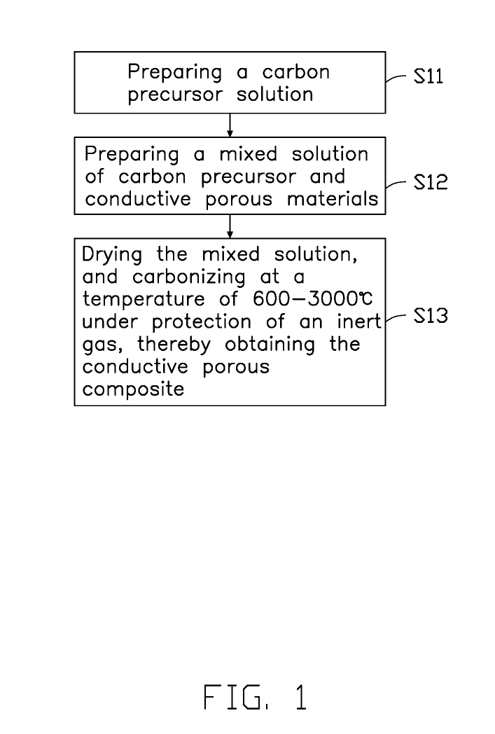

FIG. 1 shows a preparing method of conductive porous composite including the following steps:

S11, preparing carbon precursor solution;

S12, preparing a mixed solution of carbon precursor and conductive porous materials;

S13, drying the mixed solution and carbonizing under under protection of an inert gas at a high temperature, the conductive porous composite is thus obtained.

The conductive porous material includes one or more of carbon porous material and non-carbon porous material.

The carbon porous material includes, but is not limited to, one or more of glass carbon, template carbon, graphene, carbon molecular sieve, carbon nanotubes, graphite oxide, carbon nanoparticles, carbon quantum dots, activated carbon, and lignin.

The carbon porous material of present disclosure is a carbon molecular sieve, preferably, the carbon molecular sieve includes but is not limited to one or more of 3KT-172 type carbon molecular sieve, 1.5GN—H type molecular sieve, rock valley carbon molecular sieve, and carbon molecular sieves CMS-180, CMS-200, CMS-220, CMS-230, CMS-240, and CMS-260.

The non-carbon porous material includes, but is not limited to, one or more of porous polymers, porous metals, porous metal oxides, porous metal sulphides, porous silicide, porous nitride, and porous alloy materials.

The non-carbon porous material includes, but is not limited to, one or more of zeolite molecular sieve and modified zeolite molecular sieve.

The modified zeolite molecular sieve includes, but is not limited to, cation exchange modification, aluminum removal modification, molecular sieve skeleton of the impurity atom, and crystal substitution.

The modified zeolite molecular sieve includes, but is not limited to, one or more of TS-1 type molecular sieves, L-molecular sieves, ZSM-5 type molecular sieves, eight-surface zeolite molecular sieves, and mercerizing zeolite molecular sieves.

The carbon precursor includes, but is not limited to, one or more of a carbon-containing organic matter, a carbon-containing polymer material, biomass.

Step S1 further includes dissolving the precursor of carbon in a solvent to obtain a precursor solution of carbon.

The solvent includes, but is not limited to, one or more of alcohols, ethers, ketones, and water.

The mass ratio of the carbon precursor and the conductive porous material is 1:2-4:1 in the step S2, the mass of the carbon precursor and the conductive porous material occupying 10-20% of the mixed solution.

Step S2 further includes adding conductive porous materials into the precursor solution of carbon, mixing evenly, and obtaining a mixed solution.

Preferably, the mixture is subjected to ultrasonic vibration for 1 hour, and then sealed with magnetic stirring for 10-12 hours.

The S3 drying step can be conventional, such as simple drying, vacuum drying, spray drying, or other similar methods.

The inert gas includes, but is not limited to, one or more of nitrogen and argon, preferably, argon.

The process of high-temperature carbonization includes the carbonization heating rate of 5° C./min, inert gas flow of 70-80 mL/min, and heating up to 600° C. and then maintaining it at a constant temperature of 600° C. for 4 hours. After carbonization, the temperature is allowed to naturally drop to room temperature (e.g., 25° C.).

The carbonization temperature can be in a range of 600−3000° C.

The present disclosure also provides a sodium ion battery electrode including the sodium ion battery electrode material as described above and auxiliary components.

The auxiliary components can include a binder. Conductive additives may also be included. The binder and the conductive additives can be used as known to person in this field.

A sodium ion battery electrode hereunder can be prepared by using the sodium ion battery electrode material of present disclosure, according to a method of preparing the sodium ion electrode known to person in this field.

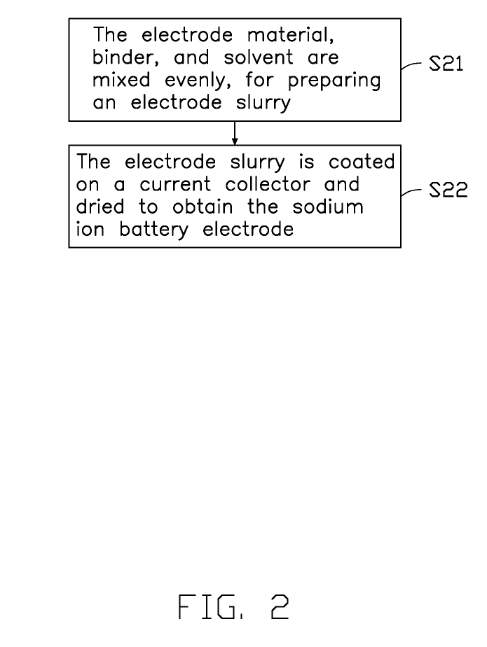

FIG. 2 provides a preparing method of a sodium ion battery electrode, including the following steps:

S21, the electrode material, binder, and solvent are mixed evenly, for preparing an electrode slurry;

S22, the electrode slurry is coated on a current collector and dried to obtain the sodium ion battery electrode.

Step S21 also includes the addition of a conductive additive.

The ratio of electrode material to binder is 8:1.

The present disclosure also provides a sodium ion battery including a sodium ion battery electrode as described above, wherein the battery electrode can be used for at least one of the cathode and anode electrodes.

Such sodium-ion battery also includes other components such as electrolyte, components such as the electrolyte can be used as known in the field.

The sodium ion electrode in this disclosure is used as an anode electrode of a sodium ion battery.

A sodium ion battery can be prepared by using the sodium ion battery electrode provided, the method of preparing the sodium ion battery being known in this field.

The preparing method of a sodium ion battery is optimized in this disclosure, and includes:

The battery electrode in present disclosure with electrolyte, a piece of glass fiber and sodium sheet are assembled into a sodium ion battery.

The initial Coulombic efficiency of the battery is more than 60%, and the capacity after 200 cycles is more than 200 mAh/g.

Further, the initial Coulombic efficiency of the sodium ion battery is more than 70%, and the capacity after 200 cycles is more than 250 mAh/g.

### Embodiment 1

The conductive material is a carbon molecular sieve 1, an effective pore diameter is 0.35 nm, a specific surface area is 5 m²/g, and a pore volume is 0.013 cm³/g.

The carbon molecular sieve 1 and polyvinylidene fluoride are dried at 60° C. in oven, and then the carbon molecular sieve 1 and polyvinylidene fluoride are grinded uniformly in the proportion of 8:1. In solvent of 1-methyl-pyrrolidone, the carbon molecular sieve 1 and polyvinylidene fluoride are mixed into uniform viscous paste. After fully stirring for 6 hours, coating the material on a current collector of copper foil. Then after fully drying for 12 hours in oven at 120° C., the anode electrodes with a diameter of 14 mm are prepared.

### Embodiment 2

The conductive material is carbon molecular sieve 2, its effective pore diameter is 0.40 nm, a specific surface area is 16 m²/g, and a pore volume is 0.015 cm³/g.

The carbon molecular sieve 2, conductive carbon black and polyvinylidene fluoride are dried at 60° C. in oven, and then they are grinded uniformly in accordance with the proportion of 8:1:1, then in solvent of 1-methyl pyrrolidone, they are mixed to an even viscous paste. After fully stirring for 6 hours, coating the material on a current collector, the current collector itself is a copper foil coated with carbon. Then after fully drying for 12 hours in the oven at 120° C., the above coated current collector is stamped to the anode electrode with 14 mm diameter.

### Embodiment 3

The conductive material is a carbon molecular sieve 3, its effective pore diameter is 0.6 nm, a specific surface area is 36 m²/g, and a pore volume is 0.15 cm³/g.

The carbon molecular sieve 3, with conductive carbon black and polyvinylidene fluoride is dried at 60° C. in oven, and then uniformly grinded in accordance with the proportion of 8:1:1, then in the solvent of 1-methyl pyrrolidone, they are mixed to an even viscous paste. After stirring for 6 hours, coating the material on a current collector of carbon coated copper foil. Then after drying for 12 hours in the oven at 120° C., the above current collector is stamped to the anode electrode with 14 mm diameter.

### Embodiment 4

Conductive material is carbon molecular sieve 4, an effective pore diameter is 0.4017 nm, a specific surface area is 78 m²/g (adsorbent is nitrogen), and a pore volume is 0.09 cm³/g.

1. Preparation of Conductive Porous Composite

A molecular sieve 4 (13X molecular sieve) and phenolic resin are accurately weighted with mass ratio 2:1. First, anhydrous ethanol is used for dissolving phenolic resin, and then the molecular sieve 4 is added, then, ultrasound vibration adsorption is applied on the material for 1 hour, sealed magnetic force is applied to stir the material for 12 hours, and then drying the material in the drying box. After that, the material is placed into the alumina ark, carbonization treatment is applied to the material in the tube furnace at 800° C. Argon gas is applied throughout the carbonization process with argon flow being 70-80 mL/min. Carbonization heating rate is 5° C./min, and once the target temperature reaches 800° C., the temperature is maintained for 4 hours. The material is continuously under argon protection after the carbonization process, and the material is cooled naturally to room temperature to obtain conductive porous composite. Agate mortar is used to grind the composite into powder, and the 200 target test screen filtration is applied to achieve particle size of about 0.078 mm.

Compared with the 13X molecular sieve, a conductivity of the carbon composite 13X molecular sieve was found to be raised to 0.13 S/cm relative to 5.20×10⁻⁹ S/cm of 13X molecular sieve. The added phenolic resin enters the pores of 13X molecular sieve and is coated on the surface of 13X zeolite to reduce the effective pore diameter of zeolite. The carbon derived from phenolic resin is mainly amorphous carbon, which is kept directly in place. Compared with the original 13X molecular sieve, the matrix structure of the carbon composite 13X molecular sieve shows minor changes and the controllability of the material is improved.

2. Preparation of Battery Electrodes

The conductive porous carbon composite, the conductive additives which is conductive carbon black, and the binder which is polyvinylidene fluoride, having a mass ratio of 7:1.5:1.5, are used for preparing the sodium ion battery electrode. The sodium ion battery electrode is prepared by using the method of exemplary embodiment 3.

### Embodiment 5

The conductive material is conductive Fe-ZMS-5 molecular sieve composite, its pore diameter is 0.50 nm, a specific surface area is 234 m²/g (adsorbent is nitrogen), and a pore volume is 0.12 cm³/g.

1. Preparation of Conductive Porous Composite

Iron-modified ZMS-5 (Fe-ZMS-5, the load of iron is 0.9%) and polyaniline are accurately weighted at a mass ratio of 1:1, first the polyaniline is dissolved in a ethylene glycol solution, and then the Fe-ZMS-5 molecular sieve is added. Ultrasonic vibration adsorption is applied on the material for 1 hour, sealed magnetic stirring for 12 hours, and then drying in the drying box. The material is then put into the alumina ark, in the tube furnace at 800° C. for the carbonization treatment. The whole carbonization process is under argon gas protection, where the argon flow is about 70-80 mL/min, carbonization heating rate is at 5° C./min, until a temperature of 1000° C. is reached. That temperature is maintained for 4 hours, and the material is cooled naturally to room temperature, thus obtaining the Fe-ZMS-5 molecular sieve composite. Then agate mortar is applied to grind the composite into powder, which are filtrated by the 200 target test screen filtration. The powder has an average particle size of about 0.075 mm.

Compared with Fe-ZMS-5 molecular sieve, the conductivity of the Fe-ZMS-5 molecular sieve composite material is increased from 6.8×10⁻³ S/cm of Fe-ZMS-5 molecular sieve to 152 S/cm.

2. Preparation of Battery Electrodes

The conductive Fe-ZMS-5 molecular sieve composite is added to conductive carbon black and the binder polyvinylidene fluoride in ratio of 7:1.5:1.5. The sodium ion battery electrode is prepared by using the method of exemplary embodiment 3.

### Embodiment 6

Conductive materials with conductive TS-1 type molecular sieve composite material, an effective pore diameter is 0.59 nm, a specific surface area is 254 m²/g (adsorbent is nitrogen), and a pore volume is 0.11 cm³/g.

1. Preparation of Conductive Porous Composite

Mass ratio of TS-1 type molecular sieves and starches is 1:4. First the starch is mixed in benzene, and then TS-1 molecular sieve is added. Ultrasonic vibration adsorption is applied for 1 hour, sealed magnetic stirring for 12 hours, and then drying in the drying box. The material is put into the alumina ark, and in the tube furnace at 800° C. for carbonization treatment. The whole carbonization process is under argon gas protection, argon flow is 70-80 mL/min, the carbonization heating rate is 5° C./min, until temperature of 2,800° C. is reached. That temperature is maintained for 4 hours, argon protection is continued after the carbonization process is over, and the material is allowed to cool naturally to room temperature, thus obtaining TS-1 type molecular sieve carbonized composite. Agate mortar is applied to grind the composite into powder, and by using the 200 target test screen filtration, the powder has an average particle size about 0.076 mm.

Compared with TS-1 type molecular sieves, the conductivity of TS-ltype molecular sieve composite is raised by 9.6×10⁻⁴ S/cm of Fe-ZMS-5 molecular sieve to 250 S/cm.

2. Preparation of Battery Electrodes

The conductive TS-ltype molecular sieve composite is added to conductive carbon black, and the binder of polyvinylidene fluoride with a proportion of the three materials in 7:1.5:1.5. The sodium ion battery electrode is prepared by using the method of exemplary embodiment 3.

### Embodiment 7

A battery electrode prepared by exemplary embodiment 2, and electrolyte (1 mol/LNaClO₄, 1:1 of ethyl carbonate and diethyl carbonate), glass fiber, the sodium tablets are assembled into sodium ion batteries.

### Embodiment 8

The battery electrode prepared by exemplary embodiment 4 and the electrode NaNi_{0.5}Mn_{0.5}O₂, electrolyte and diaphragm groups, are assembled into sodium ion batteries.

The initial Coulombic efficiency of the prepared sodium ion battery under 100 mA/g current is 61% and the capacity is 260 mAh/g.

Contrast 1

The method for preparing the sodium ion battery electrode is the same as that for exemplary embodiment 2, the difference being that the electrode material used is graphite. The prepared sodium ion battery electrode is assembled into a sodium ion battery using the method of the exemplary embodiment 7.

A comparison of sodium-ion batteries by exemplary embodiment 7 and contrast 1 can be seen in table 1 below. It can be seen from the initial Coulombic efficiency of the cycle of the sodium ion battery as per embodiment 7 can be 73%, but the initial Coulombic efficiency of the sodium ion battery prepared by the contrast 1 can only reach 34%. Battery capacity after 500 cycles can be seen, the battery capacity of the embodiment 7 can be 240 mAh/g, and the battery capacity of contrast 1 only 32 mAh/g.

Table 1 shows initial Coulombic efficiency of sodium ion batteries and the capacity comparison table after 500 cycles.

TABLE 1

| | Initial Coulombic | Capacity after 500 cycles |
|---|---|---|
| | efficiency % | mAh/g |
| contrast 1 | 34 | 32 |
| as per embodiment 7 | 73 | 240 |

Changes and adjustments can be made according to technical conceptions of present disclosure, and such changes and adjustments fall within the scope of protection of present disclosure.

What is claimed is:

1. A sodium ion battery electrode material comprising:
a conductive porous material or a conductive porous composite, wherein a sodium accommodating pore is defined inside the electrode material, and
an effective pore diameter for sodium ion storage is in a range of 0.2-50 nm.

2. The sodium ion battery electrode material of claim 1, wherein the conductive porous composite comprises a carbon molecular membrane and the conductive porous material.

3. The sodium ion battery electrode material of claim 1, wherein the conductive porous material comprises one or more of a carbon porous material and a non-carbon porous material.

4. The sodium ion battery electrode material of claim 3, wherein the carbon porous material comprises one or more of glassy carbon, templated carbon, graphene, carbon molecular sieves, carbon nanotubes, graphite oxide, carbon nanospheres, carbon quantum dots, activated carbon, and lignin.

5. The sodium ion battery electrode material of claim 3, wherein the carbon porous material is at least one carbon molecular sieve.

6. The sodium ion battery electrode material of claim 3, wherein the non-carbon porous material comprises one or more of a porous polymer, a porous metal, a porous metal oxide, a porous metal sulfide, a porous silicide, a porous nitride, and a porous alloy material.

7. The sodium ion battery electrode material of claim 6, wherein the non-carbon porous material comprises one or more of a zeolite molecular sieve and a modified zeolite molecular sieve.

8. The sodium ion battery electrode material of claim 2, wherein the carbon molecule membrane is made by carbonization of a carbon precursor, and the carbon precursor comprises one or more of carbon-containing organic matter, carbon-containing polymer material, and biomass.

9. The sodium ion battery electrode material of claim 1, wherein a specific surface area of the sodium accommodating pore is in a range of 0.5-2500 m²/g, a pore volume of the sodium accommodating pore is in a range of 0.0102-1.8 cm³/g.

10. The sodium ion battery electrode material of claim 9, wherein the effective pore diameter of the sodium accommodating pore is in a range of 0.3-20 nm, the specific surface area of the sodium accommodating pore is in a range of 1-1000 m²/g, and the pore volume of the sodium accommodating pore is in a range of 0.0136-1.5 cm³/g.

11. The sodium ion battery electrode material of claim 10, wherein the effective pore diameter of the sodium accommodating pore is in a range of 0.35-2 nm, the specific surface area of the sodium accommodating pore is in a range of 2-300 m²/g, and the pore volume of the sodium accommodating pore is in a range of 0.0136-0.17 cm³/g.

12. The sodium ion battery electrode material of claim 11, wherein the effective pore diameter of the sodium accommodating pore is in a range of 0.35-0.6 nm, the specific surface area of the sodium accommodating pore is in a range of 5-78 m²/g, and the pore volume of the sodium accommodating pore is in a range of 0.013-0.15 cm³/g.

13. The sodium ion battery electrode material of claim 1, wherein a depth of the sodium accommodating pore is in a range of 0.2-5 nm, and the sodium accommodating pore of the conductive porous material occupies more than 50-60% of the total number of pores in the material.

14. A method for preparing a sodium ion battery electrode material of claim 1, the method comprising:
preparing a carbon precursor solution;
preparing a mixed solution of carbon precursor and conductive porous material;
drying the mixed solution, and carbonizing at a temperature of 600-3000° C. under protection of an inert gas, thereby obtaining a sodium ion battery electrode material comprising conductive porous composite.

15. The method of claim 14, wherein a mass ratio of a precursor of the carbon and the conductive porous material is 1:2-4:1, and a mass of the precursor of the carbon and the conductive porous material is about 10-20% of the mass percentage of the mixed solution.

16. A method for preparing a sodium ion battery electrode, the method comprising:
mixing electrode material of claim 1, binder and solvent evenly, for preparing an electrode slurry;
coating the electrode slurry on a current collector and drying to obtain a sodium ion battery electrode.

17. The method of claim 16, further comprising adding a conductive additive in the mixing step to form the electrode slurry.

18. The method of claim 16, further comprising stamping the coated current collector after drying to obtain the sodium ion battery electrode.
